(19) United States
(12) Patent Application Publication
(10) Pub. No.: US 2007/0214091 A1
(43) Pub. Date: Sep. 13, 2007

(54) ELECTRONIC PAYMENT INSTRUMENT SYSTEM AND METHOD

(75) Inventors: Kurt L. Hansen, Parker, CO (US); Wade Nelson, Castle Rock, CO (US); Dean A. Seifert, Dublin (IE); Assaad G. Hanna, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 11/683,977

(22) Filed: Mar. 8, 2007

Related U.S. Application Data
(63) Continuation-in-part of application No. 11/240,755, filed on Sep. 30, 2005.
(63) Continuation-in-part of application No. 11/132,710, filed on May 18, 2005.
(60) Provisional application No. 60/781,252, filed on Mar. 9, 2006.

(51) Int. Cl. G06Q 20/00

(52) U.S. Cl. 705/64; 705/79

(57) ABSTRACT

A payment instrument that may be purchased at a retail location and used for conducting money transfers and other financial transactions. The amount associated with the instrument is stored in an non-banking account maintained by a money transfer entity. In order to activate the instrument after it has been purchased, a customer links the instrument to a personal profile of the customer using a PIN provided with the instrument.

### CROSS-REFERENCES TO RELATED APPLICATIONS

This application claims the benefit of U.S. Provisional Application No. 60/781,252 filed Mar. 9, 2006, entitled “ELECTRONIC PAYMENT INSTRUMENT SYSTEM AND METHOD.” This application also is a continuation-in-part of U.S. patent application Ser. No. 11/240,755, filed Sep. 30, 2005, entitled “Money Transfer System And Method,” and a continuation-in-part of U.S. patent application Ser. No. 11/132,710, filed May 18, 2005, entitled “Money Transfer Cards, Systems And Methods,” the complete disclosures of which are herein incorporated by reference.

### BACKGROUND OF THE INVENTION

The present invention relates generally to the field of transaction payments, and in particular to instruments that may be purchased at retail locations in order to facilitate money transfer and other payments.

Money transfer and similar arrangements are used by many consumers in lieu of bank accounts to send money, make payments and conduct similar transactions. Some consumers use such arrangements in lieu of a bank account because they may be less affluent, may not have a sufficient credit history, or does not have a permanent address. Other consumers prefer anonymity with respect to their transactions. Thus, rather than money being held in a traditional banking account, a customer provides cash to a money transfer company (e.g., Western Union) where it may be transferred (immediately after payment or later in time) to another person. The money paid to the money transfer company is not held in a federally (FDIC) insured or regulated account of the customer, but rather is merely held by the transfer company under a promise to pay the money to a person designated by the customer.

Present money transfer procedures typically involve an individual going to a money transfer location, such as a Western Union office, and giving the customer service representative a variety of personal information. This personal information may include the names and addresses of the sender and recipient, proof of identification, and the amount to be transferred. This information is entered into a money transfer system, and is used to create a record of the money transfer. After the money to be transferred has been collected from the sender, the sender notifies the recipient of the transfer. The recipient usually then goes to a separate money transfer location, such as another Western Union location, to pick up the money. The recipient may be required to provide a money transfer number and/or proof of identification, prior to picking up the money.

Similar processes are also known for making payments to creditors, such as mortgage payments and car payments. For example, the Quick Collect service available from Western Union permits an individual to go to a money transfer agent (or to a Western Union website), provide personal customer information and creditor information (e.g., account number, etc.), and arrange for a payment to the creditor.

Present procedures discourage some customers from using money transfer and other payment systems. People who frequently send money using money transfer systems find that they need to make frequent trips to offices or locations designated for money transfers. Each visit requires that the sender provide personal information to the customer service representative at the time money is deposited. Even if a person does not frequently send money, it can be a burden to transfer money, since the customer has to first locate a money transfer location, and then take the time to visit the money transfer office, and provide the necessary personal information.

Further, such procedures are typically limited to certain kinds of transactions, e.g., payments can be made for money transfers and payments to certain creditors, but are not generally available to use for on-line purchase payments (when the customer does not have a traditional banking account).

### BRIEF SUMMARY OF THE INVENTION

There is provided, in accordance with embodiments of the present invention, methods and systems for providing payment instruments that may be purchased by customers at retail and other locations, with a personal identifier (e.g., PIN) provided at the time of purchase, in order to link the payment instrument to personal information (e.g., a profile) of the customer.

In one embodiment, a method for conducting financial transactions includes providing, for purchase at a retail or other location, an instrument (which may be in the form of a card) capable of having a monetary value associated therewith and for use by a customer in performing one or more financial transactions, storing monetary value associated with the instrument in an customer account maintained by a non-banking entity, providing a personal identifier (PIN) that is associated with the instrument, creating a customer profile having personal data and relating to one or more types of financial transactions that may be completed by using the value associated with the instrument, and linking the instrument to the customer profile by associating the PIN with the customer profile.

### BRIEF DESCRIPTION OF THE DRAWINGS

FIG. 1A illustrates a payment instrument in the form of a card, mounted on a card carrier for display at a retail establishment, according to on embodiment of the invention.

FIG. 1B is a rear view of the payment instrument of FIG. 1A.

FIG. 1C is the same view as FIG. 1B, illustrating an alternative embodiment of the payment instrument.

FIG. 2 illustrates a receipt issued to a customer purchasing a payment instrument at a retail establishment.

FIG. 3 illustrates a system for purchasing and using the payment instrument illustrated in FIG. 1A.

FIG. 4 is a flow diagram illustrating the operation of the system of FIG. 3, as part of a process to purchase and activate a payment instrument.

FIG. 5 illustrates a screen display used for creating a customer profile.

FIG. 6 is a flow diagram illustrating the use of a payment instrument to conduct a money transfer transaction.

FIG. 7 illustrates a screen display used for conducting a transaction with an activated payment instrument.

### DETAILED DESCRIPTION OF THE INVENTION

Among other things, the present invention provides systems and methods for convenient purchase and funding of a payment instrument that can be used by a customer for transferring money to another person or entity. While the scope of the term “transferring money” is intended to include traditional “money transfers” (i.e., the customer as a sender transferring money to a recipient who picks up the money at a money transfer office), other payment transactions are contemplated. For example, the payment instrument may be used to make purchases at participating on-line vendors, make bill payments to creditors, and so forth. The customer may purchase the payment instrument and conduct transactions using the instrument without having to locate a money transfer office. The customer purchases the payment instrument at a convenient location, such as a retail or merchant location. As one example, instruments may be displayed for sale near the checkout lane of a retail grocery store, so that a person making grocery purchases may conveniently select an instrument and provide it along with other purchases/grocery items to the clerk for purchase at checkout. No personal information needs to be provided to the retail clerk to purchase the instrument, and the price of the instrument may be simply added to the total price of all items being purchased at the store.

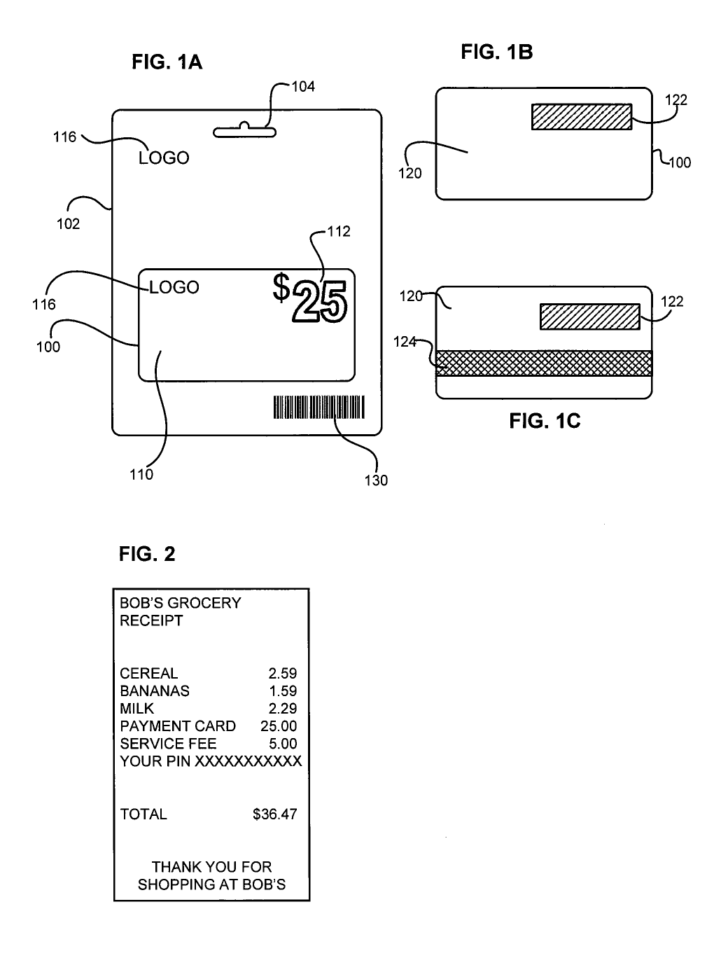

It should be appreciated that the term “instrument” is used herein in its broadest sense, and may be implemented in many different tangible and intangible forms. For example, it could include (but is not limited to) a card-like structure (as illustrated in FIGS. 1A-1C), a package, a smart card, a ticket, or any other tangible item that may be selected by a customer and that bears product information (to be described below) that can be used to identify the instrument for purchase at a POS terminal. It could also be implemented in a virtual or intangible form, for example, product information that is displayed to a customer at a retail location, which information the customer takes and then presents to the POS terminal for purchase. As should be understood from the above, the instrument and its stored value may be associated with an account maintained by a non-banking entity, e.g., a payment service provider such as Western Union or the like.

In one embodiment, the payment instruments each have a displayed face value or denomination, say $25, so that the customer knows the purchase price when the instrument is selected. A service or money transfer fee may also be displayed on the instrument, which may be added to the face value for the total purchase price. However, the instrument need not have a face value, but rather may be loaded with a monetary amount selected by the customer at the time of purchase. The instrument package carries product identification (ID) information or data, e.g., in the form of a UPC code, that can be scanned and read at the POS terminal. Other forms of product ID could be employed, such as SKUs, printed product numbers and so forth, which may be manually entered by the clerk at the POS terminal, or product ID data electronically stored on a magnetic stripe or smart card chip that may be read at the POS terminal. The instrument could also incorporate an RFID (Radio Frequency Identity Device) that electronically transmits product data. The product data in each of these examples identifies the product and its face value (if applicable) in order to facilitate purchase of the instrument, and also to facilitate, if appropriate, collection of payment instrument data that can be printed on a receipt along with any other items being purchased at the store.

In order for the customer to activate (or fulfill) the payment instrument for use, a personal identifier is provided to the customer. In some embodiments, the personal identifier is a PIN (personal identification number) that may appear somewhere on the instrument (e.g., where it is not accessible until after purchase). In other embodiments, the PIN is issued to the customer at the time of purchase (e.g., printed on a receipt). The PIN can be later used by the customer, at a place and time convenient to that customer, to associate the value of the instrument with personal profile information of the customer. As should be appreciated, the personal identifier or PIN could be any unique identifier (e.g., a string of numbers, letters or other characters) or set of identifiers.

The association of the PIN with a personal profile of the customer may be done in a number of different ways, to suit the convenience of the customer. In some embodiments, this may be done later (after purchase of the instrument) by the customer using a telephone (e.g., from the convenience of the customer's home) to call a money transfer provider and simply give the PIN and the necessary personal information to a customer service representative (e.g., name and address of customer, and if a money transfer to an individual is the desired transaction, then also the name of recipient, pick-up location, and so forth). Among other possibilities, the call could also be handled by an automated Interactive Voice Response (IVR) system using the key pad of a phone and/or voice responses in order to provide the PIN and any required personal information. In other embodiments, the customer (sender) can use a personal computer, PDA, wireless phone, WAP (Wireless Application Protocol) enabled phone or other terminal to enter required information at an internet website operated by the money transfer provider. In yet other embodiments, personal information could be entered at a self-service terminal (e.g., ATM) at a publicly accessible location. Of course, the personal information could also be presented in person at a money transfer office.

In some embodiments of the invention, when the customer desires to use the instrument to transfer money to another person for pick-up, features are provided to facilitate the receipt of the money by the recipient. This can be accomplished through the use of a control identifier, such as a money transfer control number (MTCN), which is provided to the sender at the time of the money transfer request. As is the case with the PIN, the MTCN may also be any unique identifier (e.g., a string of numbers, letters or other characters), or could be a set of identifiers (e.g., that could be combined together to provide a unique identifier). A money transfer system generates the MTCN for the sender to provide to the recipient, e.g., when the sender informs the recipient that the money is available for pick-up. When the recipient then visits a money transfer location to pick-up the transferred money, the MTCN provides a convenient reference to permit a record of the transfer (including, e.g., the name of the recipient and the amount transferred) to be automatically retrieved at the money transfer location for cash payout to the recipient.

In some embodiments, the customer may have previously established a personal profile, and the customer associates the existing profile with the newly purchased payment instrument. In other embodiments, the customer may reload an existing payment instrument (e.g., at a retail location or by directly interfacing with the money transfer system), and associates the reloaded or new value with profile information by using an existing PIN. In yet other embodiments, the customer may associate multiple profiles with the instrument (e.g., when the instrument amount or value may be used by several different family members and each family member has his/her own profile), or may associate several instruments with a single profile (e.g., to aggregate value from several instruments that individually may not have enough value for a transaction).

Referring to FIG. 1A, an exemplary payment instrument or card 100 is illustrated. The card 100 is mounted on a card carrier 102. The card 100 and carrier 102 may be displayed for purchase at a retail location, such as a grocery store, convenience store, gas station, department store, etc. It is intended that cards 100 may be offered for sale at any convenient retail location that a customer may visit to make purchases, so that the customer does not have to locate and make a separate trip to a dedicated money transfer office/station, or otherwise follow the traditional process used for depositing money for transfer.

The front side 110 of the instrument (FIG. 1A) is illustrated as having a face value (e.g., $25) printed prominently at a location 112. While not shown, the card (or carrier) may also display a service fee to be included in the purchase price (the service fee is the fee charged by the system for administering the payment instrument). The front of the instrument (as well as the carrier 102) may also include a logo 116, as well as any other promotional or useful information (or graphics) for the customer to see when selecting the instrument 100.

The back side 120 of the instrument is illustrated in FIG. 1B, and has a location 122 where a PIN may be printed. In the illustrated embodiment, the location 122 is concealed with a scratch-off surface, permitting the customer to remove the scratch-off surface and see the PIN after the card has been purchased (and separated from card carrier 102).

In an alternative embodiment seen in FIG. 1C, the back side of the card 120 also carries a magnetic stripe 124 that may carry electronically encoded information, such as the PIN. This enables the PIN to be electronically read when activating the card, i.e., associating the PIN with personal information of the customer. Alternatively, the encoded information could be carried on the card by an RFID device, smart card chip, bar code or other means. In some embodiments, the encoded information may also include an account number or other information associated with the payment instrument.

The front of the carrier 102 also has a UPC code 130. The clerk at the retail store may use an optical scanner at a POS terminal to read the UPC code in order to electronically retrieve product information or identification, including pricing information, at the time of purchase.

A slot 104 on carrier 102 permits the instrument 100 to be hung from J hooks or the like at the retail store for convenient display to customers. As should be appreciated, the instruments may be displayed so that instruments having different denominations or face values ($25, $50, $100, etc.) may be selected by the customer. The UPC code 130 will correspond to the face value of the instrument so that the proper face value (and service fee) will be known to the POS terminal after the UPC code is scanned. In embodiments where the instrument does not have a face value, but rather is loaded with any value chosen by the customer when the instrument is purchased, the clerk would not only scan the UPC code 110, but also be prompted at the POS terminal to enter the amount of money that is being loaded onto the instrument by the customer. The clerk would then collect the purchase price (loaded value plus service fee) from the customer. Further, in some embodiments the card can be reloaded (with money) at a retail or other location so that it can continue to be used for money transfers or other transactions after the initial value has been depleted. For example, when a customer desires to reload, the card could be taken to a retail location and the magnetic stripe 124 read to identify the instrument. The amount to be reloaded onto the card could then be tendered by the customer.

In some embodiments, a PIN is issued at a POS terminal when the card is purchased (rather than appearing on the card), and in such case the PIN is printed on a receipt or other document at the POS terminal for later use by the customer. FIG. 2 illustrates an exemplary receipt that might be printed at the POS terminal in response to the purchase of a payment instrument 100. As seen in FIG. 2, the receipt shows each of the items purchased (and its cost) at a retail location, including a description of the payment instrument (a $25 card in the illustrated example) and a service fee ($5 in the illustrated example). Printed immediately below the description of the payment instrument and the service fee is the PIN to be used by the customer when activating the payment instrument.

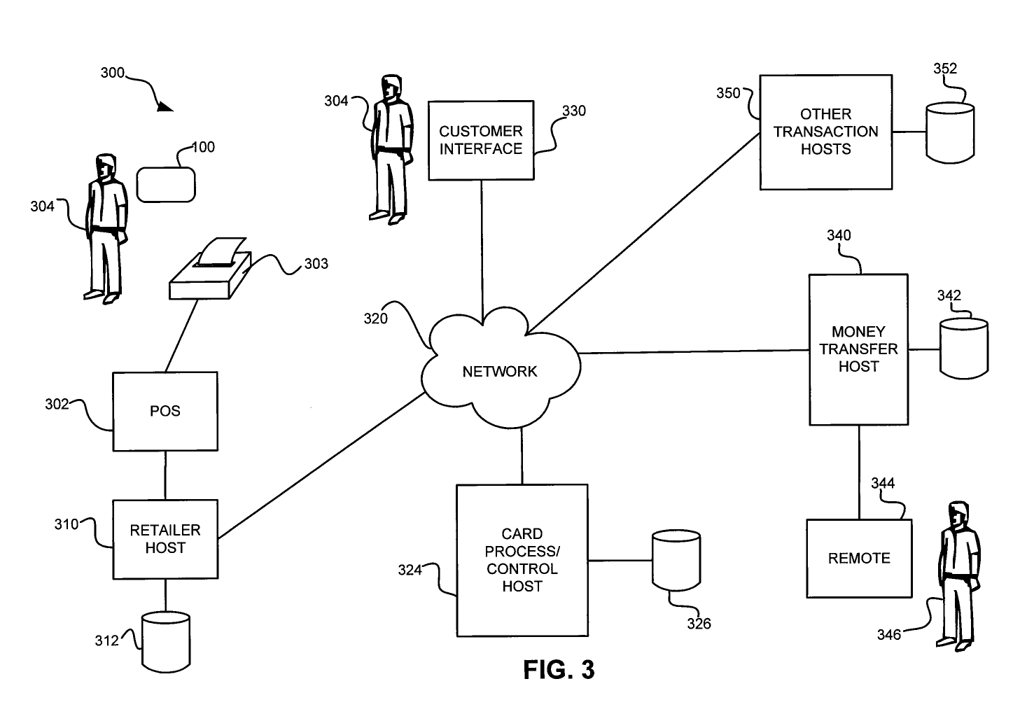

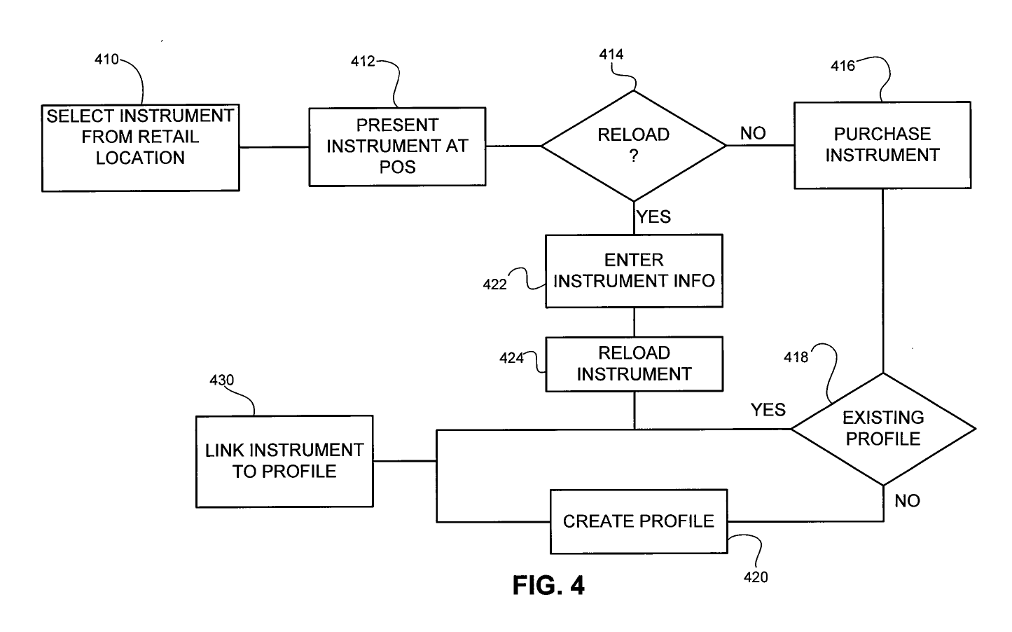

FIG. 3 illustrates a system 300 for facilitating the purchase and use of payment instruments. As seen, the system includes POS terminals 302 where a customer 304 may purchase an instrument or card 100 at a retail establishment. The retail establishment has a retail server or host 310 connected to the POS terminals 302. Among other things, the host 310 may handle centralized inventory, price look-up and other database storage and retrieval functions using a database storage device 312. The retail host 310 is connected via a dedicated or public network 320 (internet, PSTN, etc.) to a remote card process/control host 324 having an associated database 326. The control host 324 (and its associated database 326) handles the activation/fulfillment of payment instruments, maintains the balance (unused value) associated with each instrument, manages the collection and maintenance of customer personal information or profiles (to be described in greater detail later) associated with each instrument, and issues and maintains PINs and money transfer control numbers (MCTNs), if required, for an instrument 100. These various functions will be described below in conjunctions with FIG. 4. However, reference can also be made to the previously mentioned application Ser. No. 11/240,755 for other details on the implementation of these functions.

The system 300 further includes a customer interface 330 through which the customer 304 may access various components of the system, a money transfer host 340 having an associated database 342 for facilitating transfers of money from the customer 304 to a recipient 346 at a remote terminal 344, and other transactions hosts 350 (and associated databases 352) through which other payment transactions (to be described) are facilitated.

Money transfer host 340 is operated by an entity that provides money transfer services and manages money transfer transactions (e.g., Western Union). The money transfer host 340 may be accessed by money transfer representatives or agents through the use of the remote agent terminal 344 (located, for example, at money transfer offices at locations remote from the host 340). Only one terminal 344 is illustrated in FIG. 3, but it should be appreciated that there could in practice be many such agent terminals, located across a network of money transfer offices where customers may be depositing or receiving money. The database 342 stores, among other things, records and data relating to money transfer transactions (completed or yet to be completed).

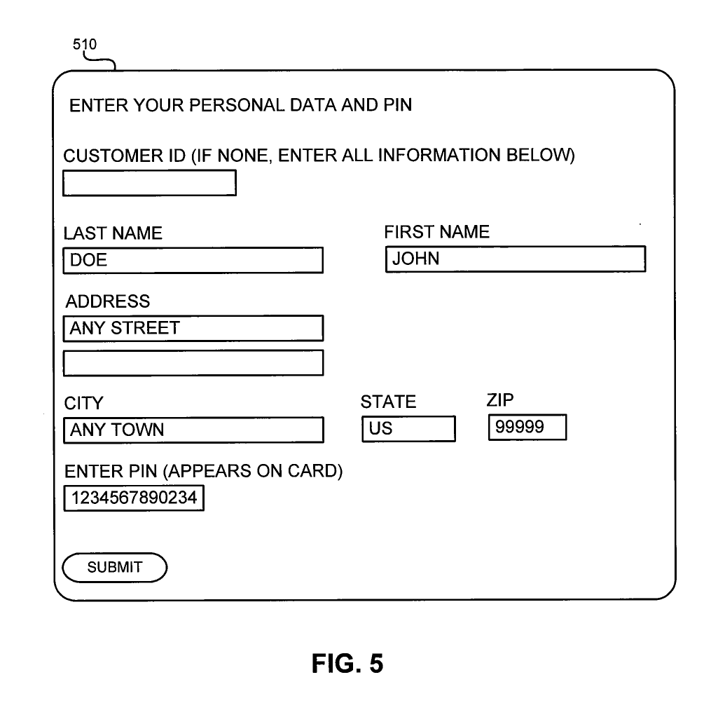

In one embodiment, control host 324 maintains in database 326 the PINs that are associated with each payment instrument available for purchase at a retail location. After a customer purchases an instrument, the customer accesses the control host 324 through the customer interface system 330 and provides the PIN in order to activate the instrument 100. The interface system 330 may provide several different user interfaces for the customer to use. As mentioned earlier, one such interface may use a telephone network, with the interface system 330 employing an Interactive Voice Response system so that a customer may dial into the interface system 330 and then enter the PIN appearing on the instrument in response to a voice prompt. If the customer has not previously created a personal profile, the customer may then be prompted to enter personal information (the personal profile thus created by the customer will be described below in conjunction with. FIG. 5). The control host then associates the PIN on the instrument with the personal profile of the customer, at which time the payment instrument 100 is activated and becomes available to conduct transactions.

Alternatively, the interface system 330 may include a web-based application, which the customer accesses using the internet and which provides instructions and data entry displays for entering the PIN and personal data. Other methods for providing the PIN and personal data are also possible, such as the customer visiting a money transfer office and providing the PIN in person (especially for customers who are uncomfortable using a telephone or web-based system).

In some embodiments, PINs are issued at the time of purchase (rather than being printed on the instrument 100), and in such case the database 326 associated with the control host 324 stores PINs to be issued to customers. Those PINs stored in database 326 are periodically assigned as needed to the retail host 310, where they are in turn made available for issuance to customers purchasing money transfer instruments. Thus, either at regular intervals (e.g., at the beginning of each day) or upon request of the host 310 when its supply of PINs is low or depleted, PINs within database 326 are downloaded through host 324 and retail host 310 for storage in database 312. Thereafter, when a UPC code is scanned for an instrument at one of the POS terminals 302, the retail host provides a PIN corresponding to that UPC code to the POS terminal where, for example, it may be printed on a receipt at a printer 303 (FIG. 3) after the purchase is completed. Further details on the issuance of PINs through hosts 324 and 310 can be found in the earlier referenced application Ser. No. 11/240,755.

Once the instrument 100 has been activated, the customer may conduct a number of different transactions at interface 330. For example, if a money transfer is desired, the customer may use the customer interface system 330 to provide information regarding the recipient, which information is supplied to the money transfer host 340. The amount of the money to be transferred (if less than the total of the amount loaded onto the payment instrument 100) may be deducted from the balance maintained on the payment instrument (at control host 324), and is stored at the money transfer host 340. Money transfer host 340 provides a MTCN to the customer at the interface (either directly or through control host 324), which can then be provided by the customer to the intended recipient. 346. The recipient visits a money transfer office and provides the MCTN (along with appropriate identification) to an agent at the remote terminal 344 in order to receive the transferred money.

In a similar manner, other transaction may be conducted by the customer 304 at the interface 330. For example, if the customer has made arrangements for paying bills to a creditor (either directly or through 3rd party payment service), such creditor or service may operate one of the hosts 350, and the bill payment can be requested at interface 330. The amount of the bill payment can be deducted from the amount loaded onto the payment instrument 100 and maintained at host 324, and then also credited to an account (for the creditor) maintained at the appropriate host 350. The account maintained at the host 350 may be a banking account of the creditor, with an ACH transfer made directly from a banking account maintained by the operator of control host 324 when the payment is requested by the customer.

As another example, if the customer desires to make a purchase on-line, the customer uses interface 330 to request such payment and identify either the on-line vendor or a third party payment service to whom such payment is to be made. The payment is deducted from the balance maintained for the payment instrument at control host 324, and is transmitted to the host maintained by the vendor. In some instances, an MTCN or the like may be issued by the control host 324 or one of the other hosts 350, and provided to the customer at the interface 330, to confirm that payment has been transferred. Such MCTN may be required by the on-line vendor from the customer before shipment of the purchased goods (so the vendor is assured that payment has been made).

FIG. 4 illustrates the purchase and activation of a payment instrument 100. The customer first selects the instrument at a retail location (step 410) and then presents it at a POS terminal (step 412). The POS terminal determines whether the card is an initial purchase or a reload (step 414), such by the clerk at the POS terminal asking the customer. If it is a reload, information identifying the instrument (such as a PIN or other card/instrument identifying information, for example, on the magnetic stripe 124 (FIG. 1C), will need to be read at the POS terminal (step 422), and the card value is increased by the selected amount (step 424), which is reflected at the host 324. As should be appreciated, in some embodiments the presentation of the instrument and the reading of identifying card information such as from magnetic stripe 124 (FIG. 1C) may be sufficient to determine whether the card is a new purchase, or one previously purchased and now being presented for reload (such as at a self-service POS terminal). If the transaction is not a reload, the card is purchased at the POS terminal (step 416), by reading the UPC code and the customer tendering payment.

The customer then separately uses (e.g., later in time) the customer interface 330 (FIG. 3) to activate the instrument and to associate a customer profile (customer personal information) with the instrument. When at the interface 330, the customer is asked whether he/she has an existing profile (step 418). If there is not an existing profile, the customer creates the profile at step 420. A screen for entering information in order to create a customer interface is illustrated in FIG. 5, to be described shortly. Finally, at step 430, the customer links the customer profile to the purchased instrument 100 by providing the PIN provided with the instrument, and thereafter the instrument may be used to conduct payment transactions.

FIG. 5 illustrates a screen 510 that may be loaded onto a customer PC from a website supported by control host 324. The screen is used to link a PIN to the customer's profile (and create a new profile if needed). As seen, if the customer already has a profile, he/she may be prompted for a customer ID associated with the profile (and all data previously entered into a profile). If there is no existing profile, then personal information (name, address, etc.) is entered on the screen. The customer then enters the PIN from the purchased instrument and submits the information to the host.

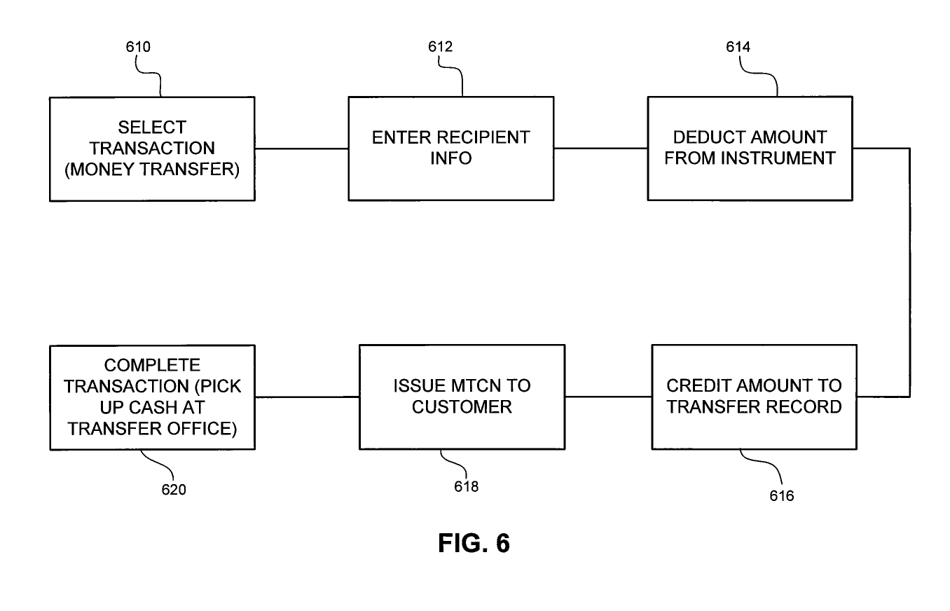

FIG. 6 is a flow diagram illustrating the use of the activated payment instrument to conduct a payment transaction. For purposes of illustration, it is assumed that the customer 304 desires to use the payment instrument to transfer money to a recipient 346 (see FIG. 3), but as previously discussed other payment transactions could be selected.

Using the customer interface 330 (FIG. 3), the customer selects the transaction (a money transfer) at step 610, and then is prompted (step 612) to enter recipient and transaction information (name, address, pick-up location, amount to be transferred, etc.). The amount transferred is then deducted from the balance on the instrument at step 614 (such debit made to the balance maintained at the control host 324), and is credited to a transaction or transfer record (step 616) maintained at the money transfer host 340. A MTCN is issued by the money transfer host 340 and is provided to the customer (either directly or through control host 324) at interface 330 (step 618). The customer may then provide the MTCN to the recipient so that the transaction can be completed when the recipient picks up the transferred money at a money transfer office (step 620).

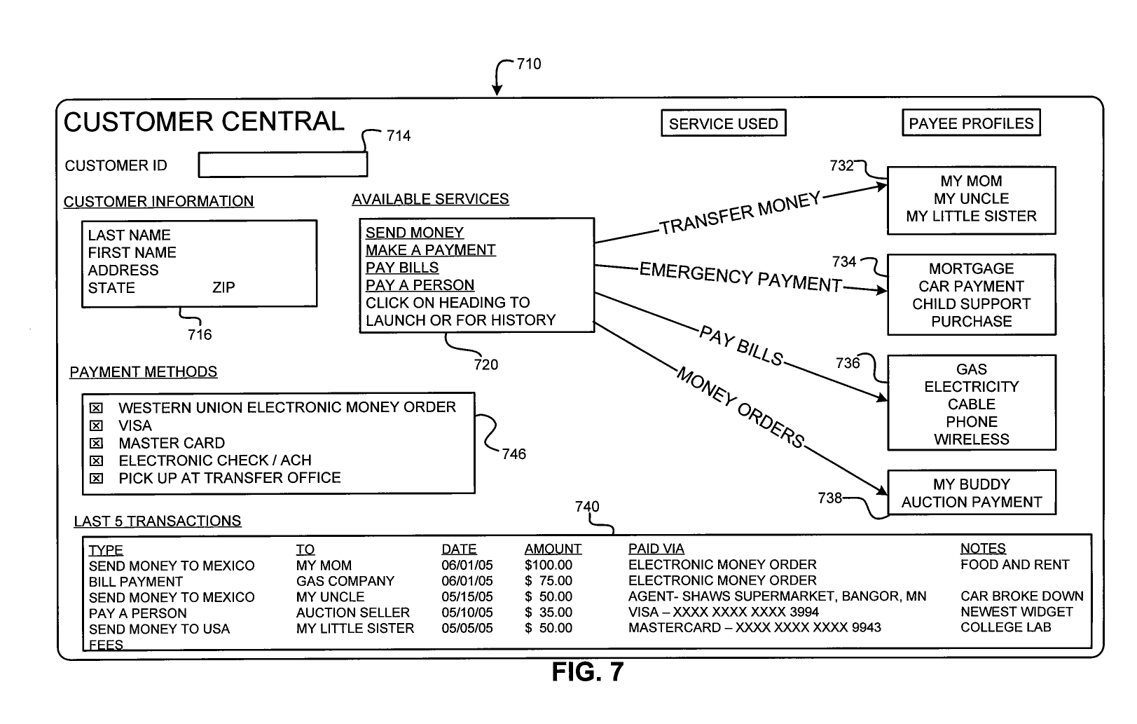

FIG. 7 illustrates a screen 710 that may be displayed at customer interface 330 in order to enable a customer to use the payment instrument 100 to select and complete transactions. In the described embodiment, it is contemplated that the screen 710 will be loaded onto a customer PC from a website maintained at the control host 324.

As seen in FIG. 7, a customer ID may be entered at screen location 712 (if known by the customer, and in lieu of providing detailed customer information at screen location 716). The customer may select the type of transaction or service at location 720, and if the transaction has been previously done (i.e., same payee), profile information from any one the payees may be displayed by selecting one of the existing payees from the payee locations 732, 734, 736 and 738. If the customer is transferring a payment to a new payee, then an additional screen would be displayed (not shown) for the customer to enter information on that payee when one of the available transaction services is selected at location 720. For the convenience of the customer, recent transaction details are displayed at a location 740. The customer may also select various payment methods (e.g., make payment to the payee by electronic money order, credit to a payee credit card or bank account, or for pick-up at a money transfer office) at location 746.

As an example, if the customer desires to transfer money to a previous recipient, the customer may select that recipient (e.g., “My Mom”) at location 732. The profile for “My Mom” would be displayed (not seen in FIG. 7) and the customer could use the same profile information (e.g., the same amount of money and the same pick-up location) or modify that information to suit the customer.

While a detailed description of presently preferred embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for conducting financial transactions, comprising:
providing an instrument for purchase, the instrument capable of having a monetary value associated therewith and for use by a customer in performing one or more financial transactions;
storing monetary value associated with the instrument in an customer account maintained by a non-banking entity;
providing a personal identifier at the time of purchase that is associated with the instrument;
creating a customer profile having personal data and relating to one or more types of financial transactions that may be completed by using the value associated with the instrument; and
linking the instrument to the customer profile by associating the personal identifier with the customer profile.

2. The method of claim 1, wherein the instrument is provided for purchase at a retail location.

3. The method of claim 2, wherein the linking of the instrument to the customer profile thereby activates the instrument for use in conducting financial transactions.

4. The method of claim 3, wherein the customer profile is created independently of the purchase of the instrument.

5. The method of claim 4, wherein the customer profile is created by the customer entering information at a customer interface system.

6. The method of claim 5, wherein the customer interface comprises an interactive voice response (IVR) system.

7. The method of claim 6, wherein the customer interface comprises a website screen display.

8. The method of claim 2, wherein the personal identifier is provided to the customer at the retail location.

9. The method of claim 8, wherein the personal identifier is a PIN appearing on the instrument.

10. The method of claim 9, wherein PIN appears on the instrument but is accessible only after purchase of the instrument.

11. The method of claim 10, wherein the instrument is packaged with a carrier for display at the retail location, wherein the PIN is not visible when the instrument is displayed, but wherein the PIN is visible when the instrument is removed from the carrier.

12. The method of claim 8, wherein the PIN is provided to the customer at a POS terminal when the instrument is purchased.

13. The method of claim 12, wherein the packaged instrument includes a UPC code to be read by the POS terminal for identifying product information associated with the instrument.

14. The method of claim 13, wherein the PIN appears on a receipt printed at the POS terminal.

15. The method of claim 1, wherein the customer account is not a federally insured banking account.

16. The method of claim 1, wherein the non-banking entity is a payment service provider and wherein the method is used for transferring money from the customer as a sender to another person as a recipient.

17. The method of claim 16, wherein the customer receives a transaction identifier when linking the personal identifier to the customer profile, and wherein the transaction identifier is provided to the recipient in order for the recipient to use in completing a money transfer.

18. The method of claim 17, wherein the transaction identifier is a money transfer control number (MTCN).

19. A system for enabling financial transactions to be conducted by a customer independently of a customer banking account, comprising:
a database for storing data representing value in an account and for storing data representing a customer profile, wherein the account is a non-banking account, wherein the account is associated with a payment instrument available for purchase by the customer at a retail location, and wherein the payment instrument is associated with a personal identifier provided to the customer in connection with the purchase for the instrument; and
an interface for entering the personal identifier in order to link the customer profile to the instrument and to the account, thereby activating the instrument for use in conducting transactions against the account.

20. The system of claim 19, wherein the payment instrument is a card, wherein the card is presented for display at the retail location on a card carrier, and wherein one of the card and card carrier has a product ID for being entered at the retail location for identifying product data associated with the payment instrument.

21. The system of claim 20, wherein the product ID is a uniform product code (UPC).

22. The system of claim 19, wherein the system further includes a POS device at the retail location for entering product data associated with the payment instrument.
